(19) United States
(12) Patent Application Publication
(10) Pub. No.: US 2007/0239863 A1
(43) Pub. Date: Oct. 11, 2007

(54) Information processing apparatus and control method

(76) Inventors: Tatsuya Aoyagi, Tachikawa-shi (JP); Koichiro Takeguchi, Hachioji-shi (JP); Tatsuya Kawawa, Nashitama-gun (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/732,881

(22) Filed: Apr. 5, 2007

(30) Foreign Application Priority Data
Apr. 7, 2006 (JP) 2006-106508

(51) Int. Cl. G06F 15/177; G06F 15/173; G06F 1/00

(52) U.S. Cl. 709/223; 713/310; 709/220

(57) ABSTRACT

According to one embodiment, an information processing apparatus includes a first system which is adapted to operate under the control of an operating system, and second system which is adapted to operate independently of the first system. The second system makes a decision of whether to start the operating system or not at regular intervals while the operating system is stopped, and makes wireless communication with the external equipment to receive data therefrom through the use of a wireless communication device and displays received data on a display device as the operating system is stopped when the operating system is not to be started.

### CROSS-REFERENCE TO RELATED APPLICATIONS

This application is based upon and claims the benefit of priority from Japanese Patent Application No. 2006-106508, filed Apr. 7, 2006, the entire contents of which are incorporated herein by reference.

### BACKGROUND

1. Field

One embodiment of the invention relates to a control technique for use with an information processing apparatus, such as a personal computer, which has, for example, a function of sending and receiving electronic mail (e-mail) wirelessly.

2. Description of the Related Art

In recent years, various battery-powered portable personal computers, such as notebook computers, have been developed. Recently, may of these computers have a wireless communication function built in to effect wireless communication with external equipment.

The provision of the wireless communication function allows users to send and receive e-mail or make access to Web sites even in places where they have gone or while moving, that is, with no restriction on place and time.

In addition, many of such computers have a function of, upon occurrence of a specific event even when they have been switched off, carrying out a process corresponding to that event. For example, a system is disclosed in JP-A 2004-334877 (KOKAI) which is equipped with an auxiliary computer device which is adapted to operate independently of a computer device and can accept various events while the computer device is on standby. This function will allow an efficient check to be made on incoming e-mail.

In the case of a portable personal computer, it is usual for the user to carry it in a bag. In a situation in which the personal computer is put in a closed space, such as the inside of the bag, which involves difficulties in radiation of heat, in view of the possibility of generation of heat it is not desirable to automatically start the system even if a specific event has occurred.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view, as viewed from the front side, of an information processing apparatus according to an embodiment of the present invention;

FIG. 2 is an exemplary perspective view of the information processing apparatus of FIG. 1 when it is closed;

FIG. 3 shows an exemplary system configuration of the information processing apparatus of FIG. 1;

FIG. 4 shows an example of a display screen of the subdisplay in the information processing apparatus of FIG. 1;

FIG. 5 shows an exemplary configuration of software in the information processing apparatus of FIG. 1;

FIG. 6 shows exemplary transitions between system states in the information processing apparatus of FIG. 1;

FIG. 7 shows an example of a criterion of decision of whether the main system is allowed to go into the power-on state when the auto function is performed in the information processing apparatus of FIG. 1; and

FIG. 8 is an exemplary flowchart illustrating the procedure of the auto function in the information processing apparatus of FIG. 1.

### DETAILED DESCRIPTION

Various embodiments according to the invention will be described hereinafter with reference to the accompanying drawings. In general, according to one embodiment of the invention, an information processing apparatus includes a wireless communication device, a first system which is adapted to operate under the control of an operating system and includes a first storage device, and a first data receiving unit configured to make wireless communication with external equipment to receive data therefrom through the use of the wireless communication device and to store the received data in the first storage device, and a second system which is adapted to operate independently of the first system and includes a display device, a second storage device, a second data receiving unit configured to make wireless communication with the external equipment to receive data therefrom through the use of the wireless communication device, to store the received data in the second storage device, and to display data stored in the second storage device on the display device, and a control unit configured to make a decision of whether to start the operating system or not at regular intervals while the operating system is stopped, to present an instruction to the first system to start the first system and operate the first data receiving unit when the operating system is to be started, and to operate the second data receiving unit as the operating system is stopped when the operating system is not to be started, the first data receiving unit including a process of transferring data stored in the first storage device to the second system to display it on the display device.

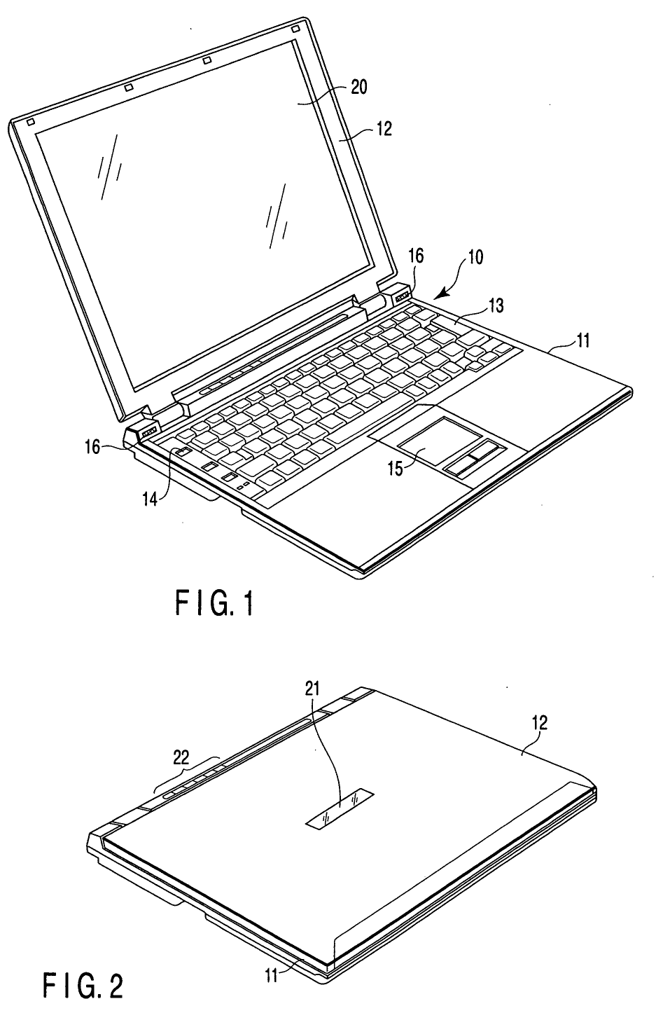

Reference is first made to FIGS. 1 and 2 to describe the configuration of an information processing apparatus according to an embodiment of the present invention. This information processing apparatus is implemented in the form of a battery-powered notebook computer 10. The computer 10 has an auto function of automatically performing a communication process of receiving data, such as e-mail, and then notifying the user of reception of new data while it is kept switched off.

FIG. 1 is a perspective view, as viewed from the front side, of the computer 10 in a state in which its display unit is held open.

The body of the computer 10 is composed of a base unit 11 and a display unit 12. The display unit 12 has a display device comprising a built-in liquid crystal display (LCD) panel 20. The display screen of the LCD panel 20 is positioned at almost the center of the display unit 12.

The display unit 12 is rotatably attached to the base unit 11 so that the notebook computer 10 can be opened or closed. The base unit 11 has a thin box-like casing and is equipped on top with a keyboard 13, a power button switch 14 to switch on or off the computer 10, and a touchpad 15. The base unit 11 has a built-in wireless communication device. In the auto function, this wireless communication device is used to effect wireless communication with external equipment, such as a mail server or other computer. The base unit 11 is equipped with a loudspeaker 16 as well.

FIG. 2 is a perspective view of the computer 10 when it is closed. The display unit 12 is equipped with a subdisplay 21 on the back. The subdisplay 21 is adapted to display various pieces of status information related to the auto function. On the subdisplay 21 are also displayed, for example, information indicating the electric field strength of a radio signal from a base station or the header information of received e-mail (time, sender, title, etc.).

The subdisplay 21 allows the user to confirm that new e-mail has been received even in a situation in which the computer 10 is both switched off and closed.

The base unit 11 is equipped with operating switches 22 on the rear. The operating switches 22 include some push button switches used to control the displayed contents of the subdisplay 21. The push button switches include a switch to scroll up and a switch to scroll down. The operating switches 22 are visible from outside even in a state in which the computer 10 is closed. The user is allowed to switch e-mail header information displayed on the subdisplay 21 piece by piece by operating the switches 22 with the computer 10 closed.

Although the subdisplay 21 is placed on the back of the display unit 12, this is not restrictive. It may be placed in any position on the body of the computer 10 provided that it is visible from outside when the computer is closed.

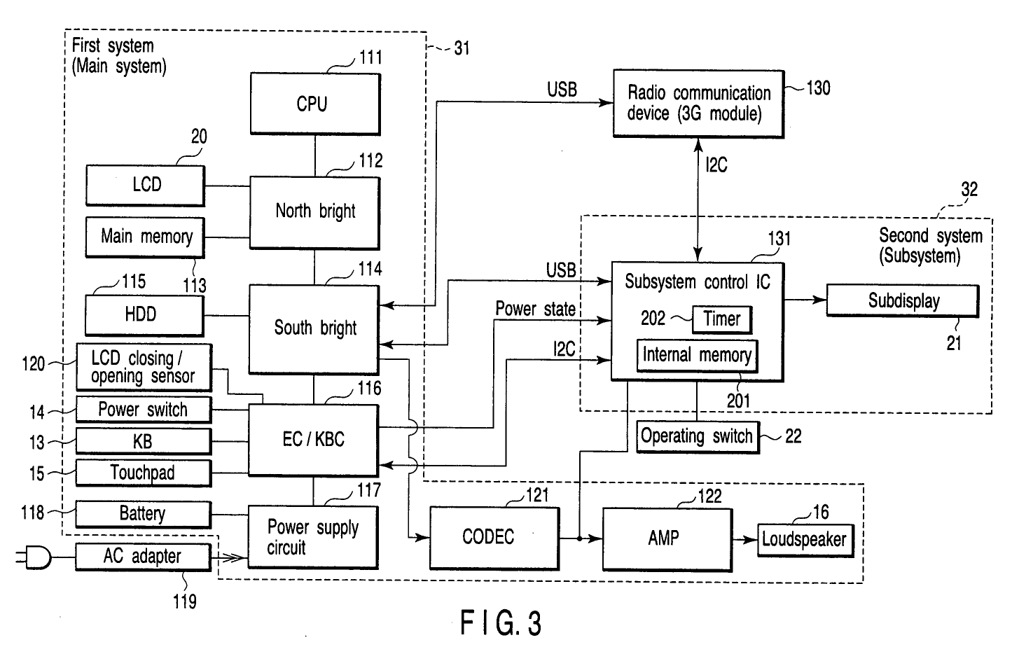

FIG. 3 shows an exemplary system configuration of the computer 10. The computer 10 has first and second systems 31 and 32 and a wireless communication device 130.

The first system 31 is the main system that is adapted to operate under the control of the operating system and is set in the base unit 11. The main system 31 operates when the power is applied to the computer 10. The main system 31 includes a CPU 111, a north bridge 112, a main memory 113, a south bridge 114, a hard disk drive (HDD) 115, an embedded controller/keyboard controller (EC/KBC) IC 116, a power supply circuit 117, an LCD opening/closing sensor 120, a codec 121, and an amplifier (AMP) 122.

The CPU 111, which is the main processor that controls the operation of the computer 10, executes an operating system and various application and utility programs which are loaded from the HDD 115 into the main memory 113. The application programs include mail software (mailer) to send and receive e-mail. The CPU 111 performs a process of sending e-mail to external equipment, such as a mail server, and a process of receiving e-mail from the external equipment by executing the mailer. The mailer manages a given storage area on the HDD 115 as a receiving tray area and stores received e-mail in that receiving tray area.

The north bridge 112 is a bridge device that provides connection between the CPU 111 and the south bridge 114. In the north bridge 112 are also built a display controller for controlling the LCD 20 functioning as the main display of the computer 10 and a memory controller for controlling the main memory 113.

The south bridge 114 functions as an I/O controller for controlling various I/O devices. Into the south bridge 114 are also built an Integrated Drive Electronics (IDE) controller for controlling the HDD 115 and a Universal Serial Bus (USB) host controller for controlling a USB device. The south bridge 114 is connected to the wireless communication device 130 by a serial bus such as a universal serial bus. Further, the south bridge 114 is connected by a serial bus, such as a universal serial bus, to a subsystem which functions as the aforementioned second system 32.

The EC/KBC 116 is a one-chip microcomputer into which an embedded controller for power supply control and a keyboard controller for controlling the keyboard (KB) 13 and the touchpad 15 are integrated. In corporation with the power supply circuit 117, the EC/KBC 116 turns on or off the power to the computer 10 in response to the user operating the power button switch 14. The power supply circuit 117 produces an operating voltage to be supplied to each component of the computer 10 from an external power-supply voltage from a battery 118 or an AC adapter 119. Even when the computer 10 is switched off, the power is applied to the EC/KBC 116 from the power supply circuit 117.

The LCD opening/closing sensor 120 supplies the EC/KBC 116 with a signal indicating whether the display unit 12 is placed in the closed state. The CODEC 121 is a conversion unit that provides conversion of a digital audio signal to analog form. The AMP 122 amplifies an analog audio signal from the CODEC 121 to drive the loudspeaker 16.

The subsystem 32 which functions as the second system is dedicated to the aforementioned auto function and is configured to operate independently of the main system 31. Even when the computer 10 is switched off, that is, even when the power is not applied to the main system 31, the subsystem 32 is supplied with the operating voltage from the power supply circuit 117. The power dissipation of the subsystem 32 dedicated to the auto function is considerably lower than that of the main system 31.

The subsystem 32 has a subsystem control IC 131 and the aforementioned subdisplay 21. The subsystem control IC 131 is a processor adapted to control the operation of the subsystem 32 and is comprised of a one-chip microcomputer, for example. The subsystem control IC 131 executes a program stored in its internal memory 201. This program contains mail software (mailer) for receiving header information of e-mail from external equipment such as a mail server. This mailer comprises a minimum of functional modules required to receive header information of e-mail. The subsystem control IC 131 is connected to the south bridge 114 in the main system 31 through a serial bus such as a universal serial bus. The control IC 131 is also connected to the EC/KBC 116 in the main system 31 by a serial bus such as an I2C bus. Further, the subsystem control IC 131 is also connected to the wireless communication device 130 through a serial bus such as an I2C bus.

While power state information from the EC/KBC 116 indicates that the main system 31 is in the power-off state, the subsystem control IC 131 inquires of the EC/KBC 116 about the condition of each of the display unit 12 (closed or open), the AC adapter 119 (connected or not), and the battery 118 (remaining power) at regular intervals, that is, each time the timer 202 measures a preset time. Based on a response from the EC/KBC 116, the subsystem control IC 131 makes a decision of whether the operating system can be started, that is, whether the main system 31 configured to operate under the control of the operating system is allowed to go into the power-on state. The criterion of decision will be described later.

If the main system 31 is allowed to go into the power-on state, then the subsystem control IC 131 instructs the EC/KBC 116 to execute the mailer that operates on the operating system. If, on the other hand, the main system 31 is not allowed to go into the power-on state, then the subsystem control IC 131 executes the mailer stored in the internal memory 201 to carry out a communication process of receiving header information of e-mail from external equipment. The received header information is stored in the internal memory 201.

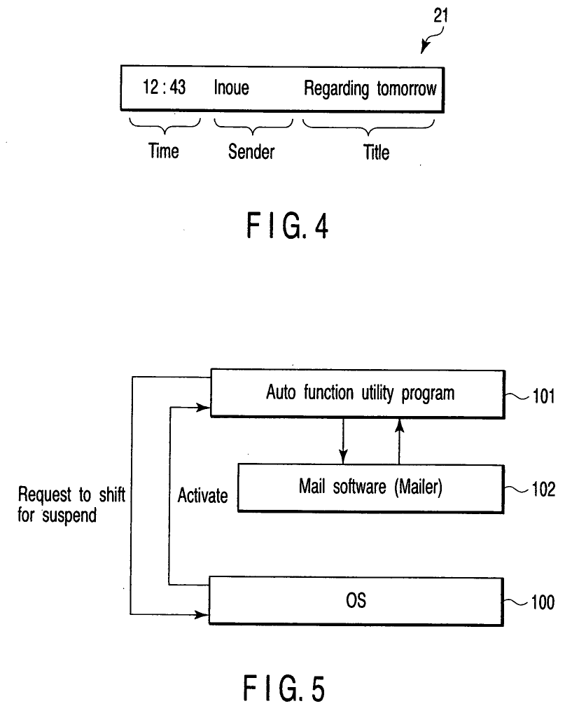

The subsystem control IC 131 also has a function of controlling the subdisplay 21 and displays the e-mail header information stored in the internal memory 201 on the subdisplay. FIG. 4 shows an example of a display of e-mail header information by the subdisplay 21. As shown in FIG. 4, “time”, “sender” and “title” contained in e-mail header information stored in the internal memory 201 are displayed in the order mentioned with “time” at the left end of the subdisplay. When an operating switch 22 is operated by the user, the subsystem control IC 131 switches header information on the subdisplay 21.

When the main system 31 goes into the power-on state and the mailer adapted to operate on the operating system is executed in response to an instruction from the subsystem control IC 131 to the EC/KBC 116, the header information of received e-mail is transferred from the EC/KBC 116 to the subsystem control IC 131, then stored into the internal memory 201 and displayed on the subdisplay 21. After execution of the mailer adapted to operate on the operating system, the main system 31 returns to the power-off state.

FIG. 5 shows the configuration of software on the main system side for implementing the auto function.

The operating system (OS) 100 is a basic program that controls the system resources. The EC/KBC 116, upon receipt of an instruction from the subsystem control IC 131, causes the computer 10 to go into the power-on state to start the operating system 100.

When started by the EC/KBC 116, the operating system 100 starts the auto function utility program, which in turn starts the mailer 102.

After the mailer 102 has been started, the auto function utility program 101 causes the mailer to carry out a process of receiving e-mail from external equipment. Next, the auto function utility program 101 obtains the header information of newly received mail stored in the receiving tray area on the HDD 115 from the mailer 102 and then transfers it to the subsystem 32.

Upon completion of transfer of the header information of the newly received e-mail to the subsystem 32, the auto function utility program 101 stops the mailer 102 and requests the operating system 100 to cause the computer 10 to go into the power-off state. The utility program then terminates. Thus, the computer 10 returns to the power-off state.

That is, in the auto function of the computer 10, when the main system 31 is allowed to go into the power-on state, it is temporarily placed in the power-on state to execute the miler adapted to operate on the operating system, store received e-mail into the receiving tray area on the HDD 115, and display the header information of the received e-mail on the subdisplay 21. If, on the other hand, the main system 31 is not allowed to go into the power-on state, the mailer on the subsystem side is executed while keeping the main system in the power-off state to display the header information of received e-mail on the subdisplay 21. In this case, the received e-mail is not stored into the receiving tray area on the HDD 115.

The wireless communication device 130 carries out wireless communication with a base station in accordance with wireless communication standards for a 3G wireless WAN, for example. The 3G wireless WAN is a wireless wide area network such as a mobile phone network. The wireless communication device 120 is supplied with an operating voltage from the power supply circuit 117 even when the computer 10 is switched off, in other words, even when the main system is placed in the power-off state.

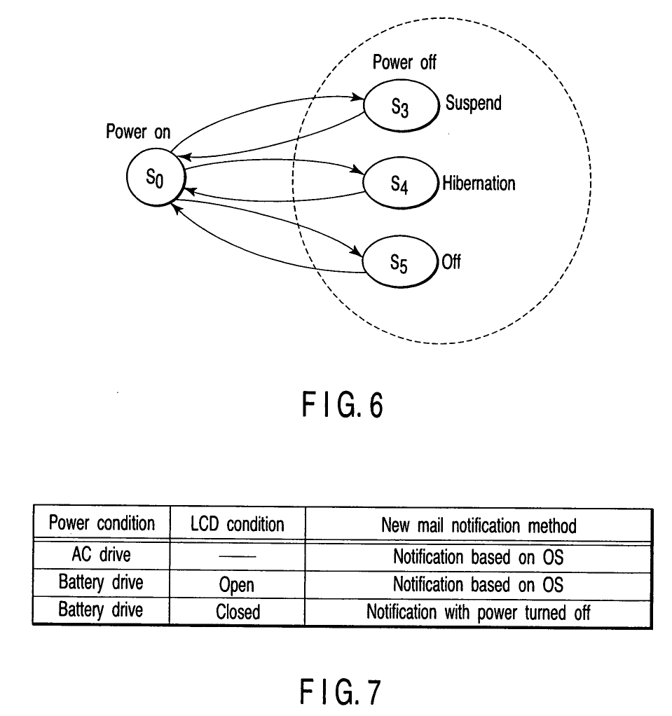

FIG. 6 shows transitions between system states (power states) of the computer 10. The computer 10 supports four system states S0, S3, S4, and S5. The state So is an operating state in which the computer 10 is switched on. In this operating state, the main system 31 operates under the control of the operating system. The states S3 (suspend), S4 (hibernation) and S5 (off) are each a low power consumption state. In each of the states S3, S4 and S5, the main system 31 will not operate.

In each of S3, S4, and S5, the EC/KBC 119, the subsystem 32 and the wireless communication device 130 are each supplied with an operating voltage. Thereby, the auto function is allowed to be performed at regular intervals by the subsystem control IC 131 of the subsystem while the computer 10 is placed in the power-off state (S3, S4, or S5). The auto function is not restricted to reception of e-mail. For example, it can also be used to download a file on a specific Web site.

FIG. 7 shows an example of a criterion of decision of whether the computer 10 can start the operating system, that is, whether the main system 31 is allowed to go into the power-on state.

The subsystem control IC 131, which inquires of the EC/KBC 116 whether the display unit 12 is closed or not, whether the AC adapter 119 is connected or not, or the power of the battery 118 is left or not, firstly examines whether external power is applied through the AC adapter. If the external power is applied (AC drive), then the control IC 131 decides that the main system 31 is allowed to go into the power-on state.

If, on the other hand, no external power is applied (battery drive), then the subsystem control IC 131 secondly examines whether the display unit 12 is open. If the display unit is open (battery drive and open), then the control IC decides that the subsystem 31 is allowed to go into the power-on state. If, on the other hand, the display unit is closed (battery drive and closed), then the subsystem control IC 131 decides that the main system 31 is not allowed to go into the power-on state. In addition, other criterion of decision may be applied. As an example, if, even when the display unit 12 is open, the remaining power of the battery 118 is less than a given amount, it is allowed to decide that the main system 31 is not allowed to go into the power-on state.

Furthermore, the computer 10 may be equipped with a light sensor, an infrared sensor, or an acceleration sensor. By applying their output signal to the EC/KBC 116, it becomes possible for the subsystem control IC 131 to recognize whether the computer is placed in a closed space, such as the inside of a bag, which is hard to radiate heat and then decide whether the main system 31 is allowed to go into the power-on state.

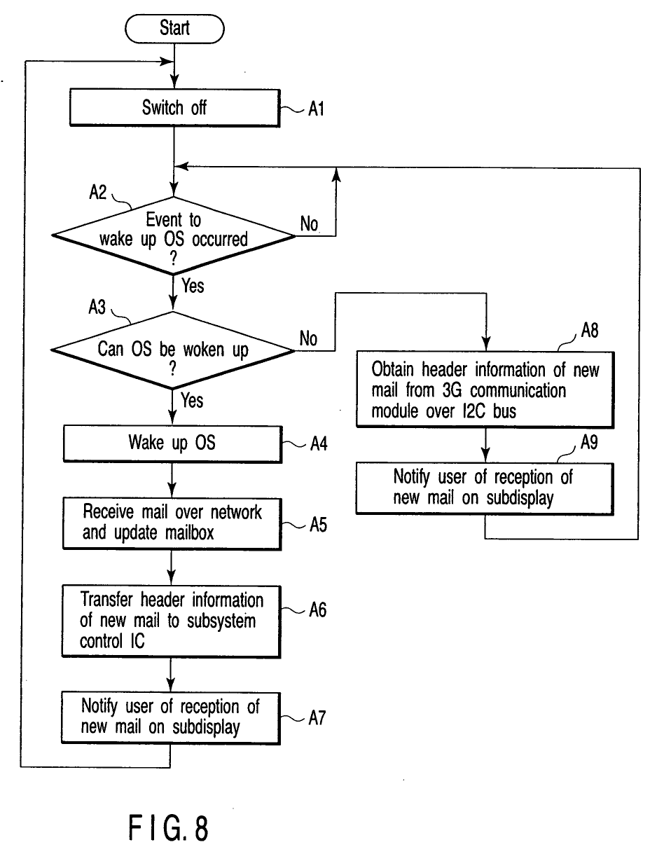

FIG. 8 is a flowchart illustrating the procedure of the auto function performed by the computer 10.

When the computer 10, i.e., the main system 31, is switched off (the aforementioned system state S3, S4 or S5) (block A1), the subsystem control IC 131 which is notified to that effect through power state information from the EC/KBC 116 causes the timer 202 to initiate time measurement. Upon lapse of a preset time (YES in block A2), the subsystem control IC 131 makes a decision of whether the main system 31 is allowed to go into the power-on state through communication with the EC/KBC 116 (block A3).

If the main system is allowed to go into the power-on state (YES in block A3), then the subsystem control IC 131 instructs the EC/KBC 116 to carry out the mailer that operates on the operating system in the main system 31. The EC/KBC 116, upon receipt of this instruction, starts the operating system 100 (block A4). Thereby, the auto function utility program 101 and the mailer 102 are started to carry out a process of receiving e-mail from external equipment through the use of the wireless communication device 130. The e-mail thus received is stored into the receiving tray area managed on the HDD 115 (block A5).

The header information of the newly received e-mail stored in the receiving tray area is transferred from the EC/KBC 116 to the subsystem control IC 131 (block A6) and then displayed on the subdisplay 21 (block A7).

If, on the other hand, the main system 31 is not allowed to go into the power-on state (NO in block A3), then the subsystem control IC 131 executes the mailer stored in the internal memory 201 to carry out a process of receiving header information of e-mail (block A8). The header information thus received is then displayed on the subdisplay 21 (block A9).

Thus, the auto function of the computer 10 is adapted to implement control corresponding to various situations. For example, it makes a check on newly arrived e-mail without starting the system in a situation in which the computer is carried in a closed space, such as the inside of a bag, which is hard to radiate heat.

The embodiment has been described by way of an example of performing the auto function each time the timer 201 in the subsystem control IC 131 measures a preset time. However, the auto function may be carried out each time the wireless communication IC 130 receives from external equipment (mail server) notification that new e-mail bound for the computer 10 is present. In this case, each time the wireless communication device 130 receives that notification, it outputs a wake-up signal to the subsystem control IC 131 so that the auto function is carried out.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a wireless communication device;
a first system which is adapted to operate under the control of an operating system and includes:
a first storage device; and
a first data receiving unit configured to make wireless communication with external equipment to receive data therefrom through the use of the wireless communication device and to store the received data in the first storage device, and
a second system which is adapted to operate independently of the first system and includes:
a display device;
a second storage device;
a second data receiving unit configured to make wireless communication with the external equipment to receive data therefrom through the use of the wireless communication device, to store the received data in the second storage device, and to display data stored in the second storage device on the display device; and
a control unit configured to make a decision of whether to start the operating system or not at regular intervals while the operating system is stopped, to present an instruction to the first system to start the first system and operate the first data receiving unit when the operating system is to be started, and to operate the second data receiving unit as the operating system is stopped when the operating system is not to be started,
the first data receiving unit configured to
transfer data stored in the first storage device to the second system to display it on the display device.

2. The information processing apparatus according to claim 1, wherein
the data contains header information,
the first data receiving unit transfers the header information to the second system, and
the second system stores the header information in the second storage device and displays it on the display device.

3. The information processing apparatus according to claim 1, wherein the second system further includes a timer, and the control unit causes the first or second data receiving unit to operate each time the timer measures a preset time.

4. The information processing apparatus according to claim 1, wherein the control unit in the second system causes the first or second data receiving unit to operate each time the wireless communication device receives from the external equipment a signal indicating the presence of new data.

5. The information processing apparatus according to claim 1, wherein
the first system further includes a power supply circuit which supplies power from a battery or an external power supply, and
the control unit in the second system decides that the operating system is to be started, when the power supply circuit supplies the power from the external power supply.

6. The information processing apparatus according to claim 5, wherein the control unit in the second system decides that the operating system is not to be started, when the power supply circuit supplies the power from the battery and the remaining power of the battery is less than a given amount.

7. The information processing apparatus according to claim 1, the apparatus is composed of a base unit and a cover unit which is attached to the base unit rotatably between a closed position in which the top of the base unit is covered and an open position in which the top of the base unit is exposed, and
wherein the control unit in the second system decides that the operating system is not to be started, when the cover unit is in the closed position.

8. The information processing apparatus according to claim 1, further comprising a sensor adapted to detect whether the apparatus is placed in a closed space, and
the control unit in the second system decides that the operating system is not to be started, when the sensor detects that the information processing apparatus is placed in a closed space.

9. An information processing apparatus comprising:
a wireless communication device including a function of receiving data from external equipment;
a first system adapted to operate under the control of an operating system and including:
a first storage device; and
a first data receiving unit configured to adapted to make wireless communication to receive data from the external equipment through the use of the wireless communication device and to store the received data in the first storage device, and
a second system adapted to operate independently of the first system and including:
a display device;
a second storage device;
a second data receiving unit configured to obtain data received by the wireless communication device, to store it in the second storage device, and to display data stored in the second storage device on the display device; and
a control unit configured to make, while the operating system is stopped, a decision of whether to start the operating system or not each time data is received by the wireless communication device, to start the operating system when the operating system is to be started to instruct the first system to operate the first data receiving unit, and to operate the first data receiving unit with the operating system stopped when the operating system is not to be started,
the first data receiving unit configured to
transfer data stored in the first storage device to the second system to display it on the display device.

10. The information processing apparatus according to claim 9, wherein
the data received by the wireless communication device contains header information,
the first data receiving unit transfers the header information to the second system to display it on the display device, and
the second data receiving unit stores the header information in the second storage device and displays it on the display device.

11. A control method for an information processing apparatus including a wireless communication device comprising, comprising:
making a decision of, while an operating system that controls resources of the information processing apparatus is stopped, whether to start the operating system or not at regular intervals;
starting the operating system and causing a first system adapted to operate under the control of the operating system to perform wireless communication to receive data from external equipment through the use of the wireless communication device, when the decision is that the operating system is to be started; and
causing a second system adapted to operate independently of the first system to perform wireless communication to receive data from the external equipment with the operating system stopped through the use of the wireless communication device, when the decision is that the operating system is not to be started.

12. The control method according to claim 11, wherein the making a decision decides that the operating system is to be started, when power from external power supply is available.

13. The control method according to claim 11, wherein the making a decision decides that the operating system is not to be started, when only power from a battery is available and the remaining power of the battery is less than a given amount.

14. The control method according to claim 11, the apparatus is composed of a base unit and a cover unit which is attached to the base unit rotatably between a closed position in which the top of the base unit is covered and an open position in which the top of the base unit is exposed, and
wherein the making a decision decides that the operating system is not to be started, when the cover unit is in the closed position.
